(19) United States
(12) Patent Application Publication
(10) Pub. No.: US 2012/0293602 A1
(43) Pub. Date: Nov. 22, 2012

(54) EXECUTIVE TELEPRESENCE SYSTEM

(75) Inventors: Tracy A. Bathurst, South Jordan, UT (US); Derek Graham, South Jordan, UT (US); Michael Braithwaite, Austin, TX (US); Russell S. Ericksen, Spanish Fork, UT (US); Bret Harris, Orem, UT (US); Sandeep Kalra, Salt Lake City, UT (US); David K. Lambert, South Jordan, UT (US); Peter H. Manley, Draper, UT (US); Ashutosh Pandey, Murray, UT (US); Bryan Shaw, Morgan, UT (US); Darrin T. Thurston, Liberty, UT (US); Michael Tilelli, Syracuse, UT (US); Paul R. Bryson, Austin, TX (US)

(73) Assignee: CLEARONE COMMUNICATIONS, INC., Salt Lake City, UT (US)

(21) Appl. No.: 13/398,662

(22) Filed: Feb. 16, 2012

Related U.S. Application Data
(60) Provisional application No. 61/443,471, filed on Feb. 16, 2011.

(51) Int. Cl. H04N 7/14

(52) U.S. Cl. 348/14.08; 348/E07.077

(57) ABSTRACT

An executive telepresence system for use in audio and video conferencing uses a unified communications system in an enterprise network system. The executive telepresence system includes a control system that further comprises a user interface, a mixing system, and a dialing system. In addition, the executive telepresence system includes one or more video display devices that couple to the control system where the video display devices display a video signal, and may further include one or more video cameras that couple to the control system where the video cameras capture video information and turn it into the video signal. Further, the executive telepresence system includes one or more microphones that couple to the control system where the microphones capture audio information and turn it into an audio signal, and may include one or more speakers that couple to the control system where the speakers play back the audio signal.

### CROSS-REFERENCE TO RELATED APPLICATION

This application claims the benefit of U.S. Provisional Patent Application Ser. No. 61/443,471, filed Feb. 16, 2011, the disclosure of which is hereby incorporated herein in its entirety by this reference.

### FIELD

This disclosure relates to executive telepresence systems. More specifically, this disclosure relates to an executive telepresence system for use in audio and video conferencing that uses a unified communications system in an enterprise network system.

### BACKGROUND

There exists a need for an executive telepresence system for use in audio and video conferencing that uses a unified communications system in an enterprise network system.

### BRIEF SUMMARY

A particular embodiment of the invention includes an executive telepresence system for use in audio and video conferencing that uses a unified communications system in an enterprise network system. The executive telepresence system includes a control system that further comprises a user interface, a mixing system, and a dialing system. In addition, the executive telepresence system includes one or more video display devices that couple to the control system where the video display devices display a video signal. The executive telepresence system further includes one or more video cameras that couple to the control system where the video cameras capture video information and turn it into the video signal. Further, the executive telepresence system includes one or more microphones that couple to the control system where the one or more microphones capture audio information and turn it into an audio signal. Additionally, the executive telepresence system includes one or more speakers that couple to the control system where the one or more speakers play back the audio signal. The executive telepresence system communicates with the unified communication system and supports the enterprise network system.

In some embodiments, the executive telepresence system can also include video display devices and video cameras that support high-definition video. In addition, the executive telepresence system can also include microphones and speakers that support high-definition audio. The executive telepresence system may communicate with a unified communication system and may also support an enterprise network system.

Another embodiment relates to a method to make an executive telepresence system for use in audio and video conferencing that uses a unified communications system in an enterprise network system. The method includes providing a control system that includes a user interface, a mixing system, and a dialing system. One or more video display devices can be coupled to the control system; the one or more video display devices display a video signal. One or more video cameras can be coupled to the control system; the video cameras capture video information and turn it into a video signal. One or more microphones can be coupled to the control system; the microphones capture audio information and turn it into an audio signal. One or more speakers may be coupled to the control system; the speakers play back the audio signal. The executive telepresence system can communicate with a unified communication system. The executive telepresence system can support an enterprise network system.

Yet another embodiment of the invention relates to a method of using an executive telepresence system in audio and video conferencing that uses a unified communications system in an enterprise network system. The method includes providing a control system that further comprises a user interface, a mixing system, and a dialing system. A video signal is displayed with one or more video display devices that couple to the control system. Video information is captured and turned into the video signal with one or more video cameras that couple to the control system. Audio information is captured and turned into an audio signal with one or more microphones that couple to the control system. The audio signal is played back with one or more speakers that couple to the control system. The executive telepresence system communicates with a unified communication system. The executive telepresence system can support an enterprise network system.

Yet another embodiment relates to a program storage device readable by a computing device that embodies a program of instructions executable by the computing device to perform a method to use an executive telepresence system for use in audio and video conferencing that uses a unified communications system in an enterprise network system. The program storage device includes a control system that further comprises a user interface, a mixing system, and a dialing system. A video signal is displayed with one or more video display devices that couple to the control system. Video information is captured and turned into the video signal with one or more video cameras that couple to the control system. Audio information is captured and turned into an audio signal with one or more microphones that couple to the control system. The audio signal is played back with one or more speakers that couple to the control system. The executive telepresence system can communicate with a unified communication system. The executive telepresence system can support an enterprise network system.

### BRIEF DESCRIPTION OF DRAWINGS

To further aid in understanding the disclosure, the attached drawings help illustrate specific features of the disclosure and the following is a brief description of the attached drawings:

FIG. 1 discloses one embodiment of an executive telepresence system.

FIG. 2 discloses another embodiment of an executive telepresence system.

FIG. 3 shows a schematic of an embodiment of the executive telepresence system.

### DETAILED DESCRIPTION

This disclosure describes an executive telepresence system for use in audio and video conferencing that uses a unified communications system in an enterprise network system. This disclosure describes numerous specific details in order to provide a thorough understanding of the present invention. One skilled in the art will appreciate that one may practice the present invention without these specific details. Additionally, this disclosure does not describe some well-known items in detail in order not to obscure the present invention.

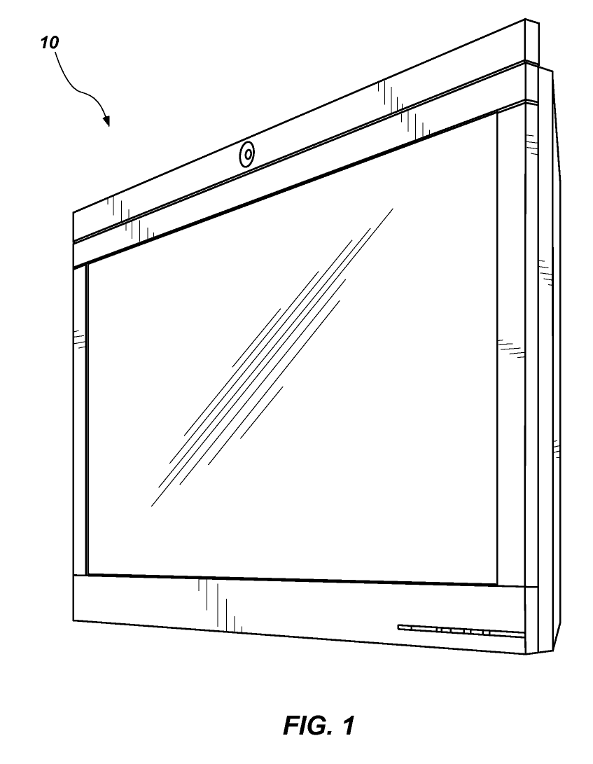

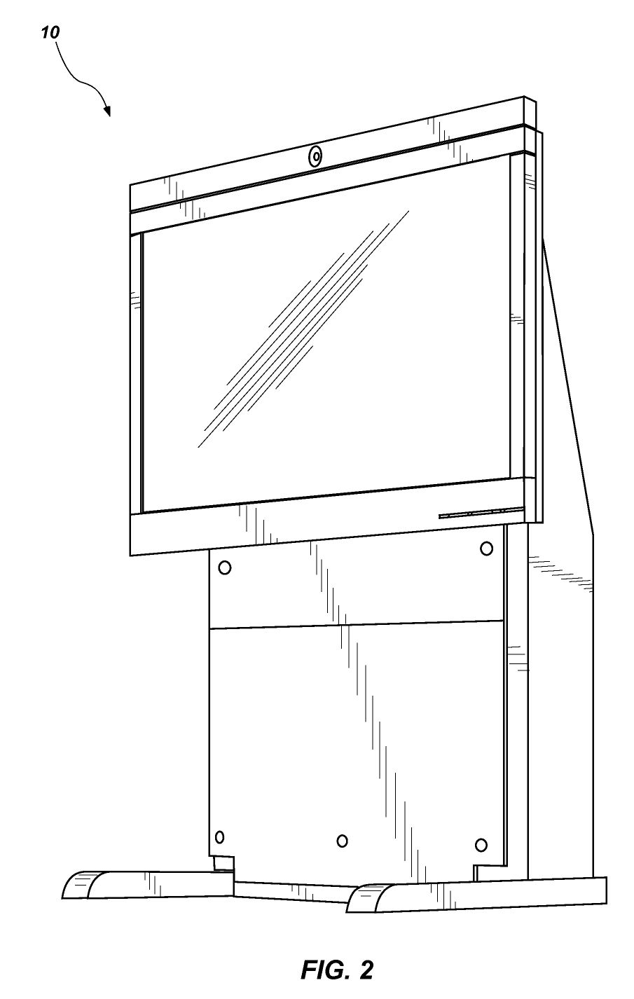

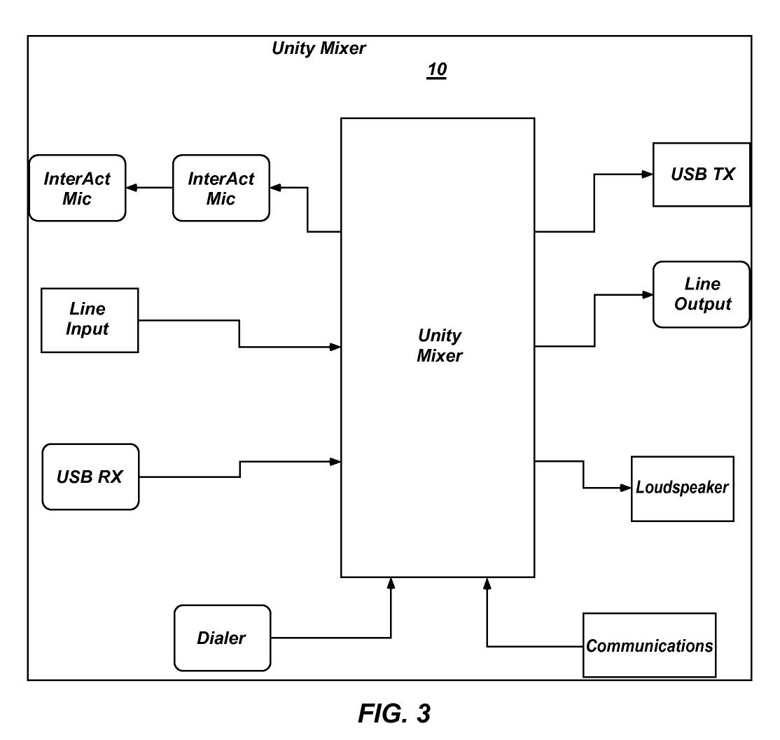

FIGS. 1 through 3 illustrate multiple embodiments of an executive telepresence system 10. One particular embodiment includes an executive telepresence system 10 for use in audio and video conferencing that uses a unified communications system in an enterprise network system. The executive telepresence system 10 includes a control system that further comprises a user interface, a mixing system, and a dialing system. In addition, the executive telepresence system 10 includes one or more video display devices that couple to the control system where the video display devices display a video signal. The executive telepresence system 10 further includes one or more video cameras that couple to the control system where the video cameras capture video information and turn it into the video signal. Further, the executive telepresence system 10 includes one or more microphones that couple to the control system where the microphones capture audio information and turn it into an audio signal. Additionally, the executive telepresence system 10 includes one or more speakers that couple to the control system where the speakers play back the audio signal. The executive telepresence system 10 communicates with a unified communication system and supports an enterprise network system.

The executive telepresence system 10 further provides that the video display devices and the video cameras support high-definition video. In addition, the system further provides that the microphones and the speakers support high-definition audio.

The executive telepresence system 10 can be adapted to include multiple configurations. For example, the executive telepresence system 10 may be configured as a single-monitor media cart version, a dual-monitor media cart version, a single-monitor wall mounting kit version, or a dual-monitor wall mounting kit version. The executive telepresence system 10 may also include unified communications, video, audio, and local presentation capabilities into a plug and play platform. It may also incorporate an all-in-one (AIO) PC that integrates PC, display, and camera devices into a single platform. The executive telepresence system 10 can be tailored for Microsoft OCS deployment with direct compatibility, and can be further visually incorporated into the OCS client application. The executive telepresence system 10 can support HD video capabilities of OCS. The executive telepresence system 10 can also allow for hands-free audio for both “video-only” and “audio-only” conferencing.

The executive telepresence system 10 can be configured to include multiple AIO PCs to meet various enterprise conferencing applications. For example, the executive telepresence system 10 can be a Windows-based group video solution that is capable of running any software-based unified communication or video conferencing client. Where dual-monitor deployment is desired, the second monitor (e.g., LCD panel) can be configured to exclude the PC and camera. The monitor/LCD panel can be based upon market available original design manufacturer (ODM) panels designed for commercial-based public displays and digital signage. The executive telepresence system 10 can incorporate a modified mixer board internally mounted inside a chassis. Modification can include the addition of USB and wireless radio on a mother board. Suitable cameras for use with the invention include embedded web cameras, high-definition cameras, and mounted cameras.

According to an embodiment of the invention, the executive telepresence system 10 for use in audio and video conferencing uses a unified communications system in an enterprise network system. The executive telepresence system 10 includes a control system that further comprises a user interface, a mixing system, and a dialing system. In addition, the executive telepresence system 10 includes one or more video display devices that couple to the control system where the video display devices display the video signal. The executive telepresence system 10 further includes one or more video cameras that couple to the control system where the video cameras capture video information and turn it into a video signal. Further, the executive telepresence system 10 includes one or more microphones that couple to the control system where the microphones capture audio information and turn it into an audio signal. Additionally, the executive telepresence system 10 includes one or more speakers that couple to the control system where the speakers play back the audio signal. The executive telepresence system 10 communicates with a unified communication system and supports an enterprise network system.

In particular embodiments, the executive telepresence system 10 further provides that the video display devices and the video cameras support high-definition video. In addition, the executive telepresence system 10 further provides that the microphones and the speakers support high-definition audio.

Other embodiments of the present invention will be apparent to those skilled in the art after considering this disclosure or practicing the disclosed invention. The specification and examples above are exemplary only, with the true scope of the present invention being determined by the following claims.

1. An executive telepresence system for use in audio and video conferencing that uses a unified communications system in an enterprise network system, comprising:
a control system that further comprises a user interface, a mixing system, and a dialing system;
one or more video display devices that couple to said control system, said video display devices configured to display a video signal;
one or more video cameras that couple to said control system, said video cameras configured to capture video information and turn it into the video signal;
one or more microphones that couple to said control system, said microphones configured to capture audio information and turn it into an audio signal;
one or more speakers that couple to said control system, said speakers configured to play back the audio signal;
wherein the executive telepresence system communicates with the unified communication system; and
wherein the executive telepresence system supports the enterprise network system.

2. The executive telepresence system according to claim 1, wherein the one or more video display devices and the one or more video cameras support high-definition video.

3. The executive telepresence system according to claim 1, wherein the one or more microphones and the one or more speakers support high-definition audio.

4. The executive telepresence system according to claim 1, wherein the one or more video display devices comprise one or more LCD monitors.

5. A method to make an executive telepresence system for use in audio and video conferencing that uses a unified communications system in an enterprise network system, comprising:
providing a control system that further comprises a user interface, a mixing system, and a dialing system;
coupling one or more video display devices to said control system, said video display devices configured to display a video signal;
coupling one or more video cameras to said control system, said video cameras configured to capture video information and turn it into the video signal;
coupling one or more microphones to said control system, said microphones configured to capture audio information and turn it into an audio signal;
coupling one or more speakers to said control system, said speakers configured to play back the audio signal;
wherein the executive telepresence system communicates with the unified communication system; and
wherein the executive telepresence system supports the enterprise network system.

6. The method according to claim 5, wherein the one or more video display devices and the one or more video cameras support high-definition video.

7. The method according to claim 5, wherein the one or more microphones and the one or more speakers support high-definition audio.

8. The method according to claim 5, wherein the one or more video display devices comprise one or more LCD monitors.

9. A method to use an executive telepresence system for use in audio and video conferencing that uses a unified communications system in an enterprise network system, comprising:
providing a control system that further comprises a user interface, a mixing system, and a dialing system;
displaying a video signal with one or more video display devices that couple to said control system;
capturing video information and turning it into the video signal with one or more video cameras that couple to said control system;
capturing audio information and turning it into an audio signal with one or more microphones that couple to said control system;
playing back the audio signal with one or more speakers that couple to said control system;
wherein the executive telepresence system communicates with the unified communication system; and
wherein the executive telepresence system supports the enterprise network system.

10. The method according to claim 9, wherein the one or more video display devices and the one or more video cameras support high-definition video.

11. The method according to claim 9, wherein the one or more microphones and the one or more speakers support high-definition audio.

12. The method according to claim 9, wherein the one or more video display devices comprise one or more LCD monitors.

13. A program storage device readable by a computing device that tangibly embodies a program of instructions executable by the computing device to perform a method to use an executive telepresence system for use in audio and video conferencing that uses a unified communications system in an enterprise network system, comprising:
providing a control system that further comprises a user interface, a mixing system, and a dialing system;
displaying a video signal with one or more video display devices that couple to said control system;
capturing video information and turning it into the video signal with one or more video cameras that couple to said control system;
capturing audio information and turning it into an audio signal with one or more microphones that couple to said control system;
playing back the audio signal with one or more speakers that couple to said control system;
wherein the executive telepresence system communicates with the unified communication system; and
wherein the executive telepresence system supports the enterprise network system.

14. The method according to claim 13, wherein the one or more video display devices and the one or more video cameras support high-definition video.

15. The method according to claim 13, wherein the one or more microphones and the one or more speakers support high-definition audio.

16. The method according to claim 13, wherein the one or more video display devices comprise one or more LCD monitors.
